(19) United States
(12) Patent Application Publication
(10) Pub. No.: US 2018/0225714 A1
(43) Pub. Date: Aug. 9, 2018

(54) LOCATION-AWARE DEVICE TRACKING SYSTEM

(71) Applicant: Walmart Apollo, LLC, Bentonville, AR (US)

(72) Inventors: Steven Lewis, Bentonville, AR (US); Nicholaus Adam Jones, Fayetteville, AR (US); Matthew Dwain Biermann, Fayetteville, AR (US)

(21) Appl. No.: 15/880,524

(22) Filed: Jan. 25, 2018

Related U.S. Application Data
(60) Provisional application No. 62/455,587, filed on Feb. 6, 2017.

(51) Int. Cl. G06Q 30/02

(52) U.S. Cl. CPC G06Q 30/0261; H04W 64/00; G06Q 30/0269; G06Q 30/0205

(57) ABSTRACT

Examples provide a location-aware device tracking system. A location-aware application on a user device scans for a wireless network using a private SSID. When a network is found, the user device connects to a store hidden network. A device tracking system gathers transaction data, including user device location based on the SSID. A location-aware analysis engine analyses the transaction data using machine learning and a predictive engine to create and/or update a user device profile. An item alert is delivered to the user device based on the user device profile and user device location data.

### BACKGROUND

Retailers, marketers, event coordinators, and other entities frequently provide information and other content associated with goods, services, events, sales, or other content to customers, potential customers, or other guests within a store or other retail location. This information may be provided to increase sales, improve attendance at an event, gain customer loyalty or goodwill. Currently, content may be made available to a customer in a variety of ways, including, signs, mailers, e-mail messages, text messages, announcements over a loudspeaker, social media posts, and so forth. However, information provided in this manner is frequently generic information not tailored to a particular recipient or location. A user profile and/or global positioning system (GPS) data associated with the particular customer may be used to customize information provided to a particular user. However, user profile data is frequently provided by the customer. Therefore, this information may be incomplete or unavailable altogether. GPS data for a customer may be unavailable as well.

Content typically cannot be tailored for a particular customer in real-time based on the user's location and/or customer preferences without access to GPS data, user profile data, and/or other information provided by one or more users. Moreover, attempting to obtain this information is frequently inefficient, unreliable, time-consuming, and/or unduly burdensome.

### SUMMARY

Examples of the disclosure provide a computing system for location-aware device tracking. The system includes a memory device storing data associated with one or more device profiles and computer-executable instructions. The system includes a processor communicatively coupled to the memory device and an analysis engine. The analysis engine obtains transaction data in real-time from one or more remote systems. The transaction data is associated with one or more locations. The analysis engine receives a request from a user device for a portion of the transaction data corresponding to a time span and a specific location from the one or more locations. The user device has a unique identifier. The analysis engine analyzes the transaction data to identify information associated with the portion of the transaction data corresponding to the requested time span and the specific location. The analysis engine outputs the identified information to the user device, associates the identified information with the unique identifier of the user device, and stores the associated information with the unique identifier in a device profile of the one or more device profiles.

Other examples of the disclosure provide one or more computer storage devices storing computer-executable instructions stored for location-aware device tracking. The computer-executable instructions are executed by a computer to receive a request from a user device for network connection using a private service set identifier (SSID); provide wireless connectivity to the user device for a specific location; identify one or more device locations for the user device within the specific location using the wireless connectivity between the user device and the network component; identify one or more items that correspond to the one or more device locations for the user device within the specific location; determine a time span associated with the wireless connectivity between the user device and the network component; obtain transaction data associated with the determined time span; and store the one or more identified items, the determined time span, and the obtained transaction data in a device profile associated with the user device.

Still other examples provide a computer-implemented method for location-aware device tracking. A user device searches for a hidden network of a specific location using a private SSID. The private SSID is used to connect to the hidden network. Location-aware information is received from a local tracking component via the hidden network. The location-aware information is stored in a device profile of the user device. The device profile is user-anonymous.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing system for location-aware device tracking.

FIG. 2 is an exemplary block diagram illustrating location-aware device tracking by a server.

FIG. 3 is an exemplary block diagram illustrating a location-aware analysis engine.

FIG. 4 is an exemplary block diagram illustrating a computing device for location-aware device tracking.

FIG. 5 is an exemplary block diagram illustrating a user device.

FIG. 6 is an exemplary flowchart illustrating operation of a computing device for generating identified information for location-aware device tracking.

FIG. 7 is an exemplary flowchart illustrating operation of a computing device for generating a device profile.

FIG. 8 is an exemplary flowchart illustrating operation of a user device for obtaining location-aware information.

Corresponding reference characters indicate corresponding parts throughout the drawings.

### DETAILED DESCRIPTION

Referring to the figures, examples of the disclosure enable location-aware device tracking. In some examples, a location-aware analysis engine is provided to generate device profiles associated with one or more user devices. The location-aware analysis engine anonymously builds a device profile associated with a given device for content generation and/or delivery to the given user device. This enables targeted content delivery to the given user device based on a user device profile while maintaining the privacy of the customer(s) using the device.

Other examples provide a location-aware application which determines a location of a user device based on a wireless network search. The location-aware application in some examples includes a set of one or more SSIDs. Each SSID is a private SSID for a network device providing a wireless local area network (WLAN) associated with a given store or other location. The location-aware application executing on a user device searches for the WLAN using the private SSID to connect the user device to the WLAN for a given location. Searching for wireless signals using the SSID consumes less power than determining a device location using GPS. This provides greater energy efficiency and improved device battery life for smart phones and other mobile user devices.

In other examples, the location-aware application tracks a user device location throughout the store using the WLAN once the location-aware application initiates a connection with the WLAN. The location of the user device at a unique store or other location is likewise determined based on the private SSID. This enables more efficient monitoring of user device locations, stores frequented by a given customer associated with a user device, frequented areas within a particular store, and other location information for a user device without utilization of GPS or manually provided user location information. This further enables delivery of location-based content in real-time in the absence of GPS data.

Other examples provide a location-analysis engine for generating device profiles. The location-analysis engine analyses transaction data associated with a plurality of user devices received from multiple different locations. The location-analysis engine utilizes analyzed transaction data and user device unique identifiers to refine device profile content through predictive analysis and machine learning while maintaining consumer anonymity. This enables improved content delivery to users with improved efficiency in an unobtrusive manner.

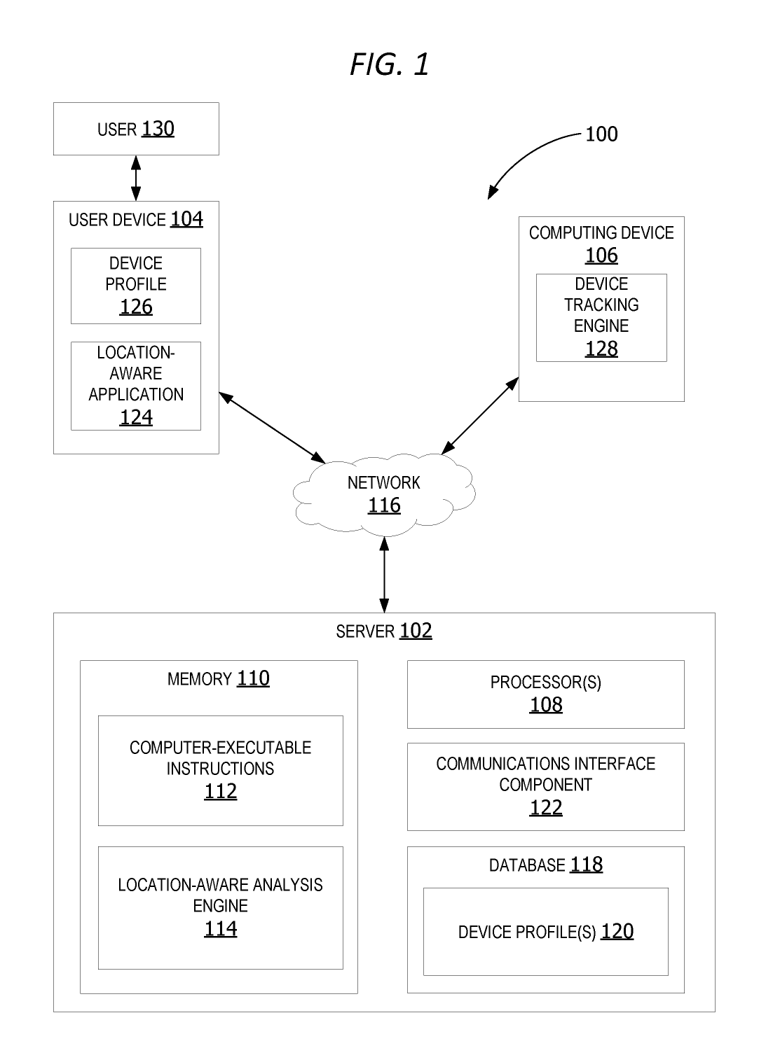

Referring again to FIG. 1, an exemplary block diagram illustrates a system for location-aware device tracking. In the example of FIG. 1, the server 102 communicating with a user device 104 and one or more remote computing devices, such as computing device 106, represents a system for location-aware user device tracking. The server 102 represents any device executing instructions (e.g., as application programs, operating system functionality, or both) to implement the operations and functionality associated with the server 102. The server 102 may include any type of server, such as, but not limited to, a blade server, an application server, or any other type of server. The server 102 may also include a desktop personal computers, kiosks, tabletop devices, industrial control devices, wireless charging stations, and electric automobile charging stations. Additionally, the server 102 may represent a group of processing units or other computing devices.

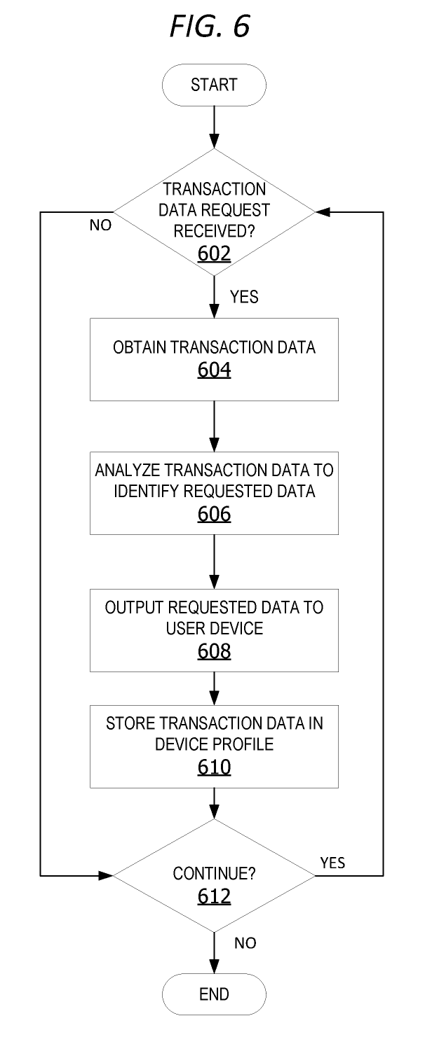

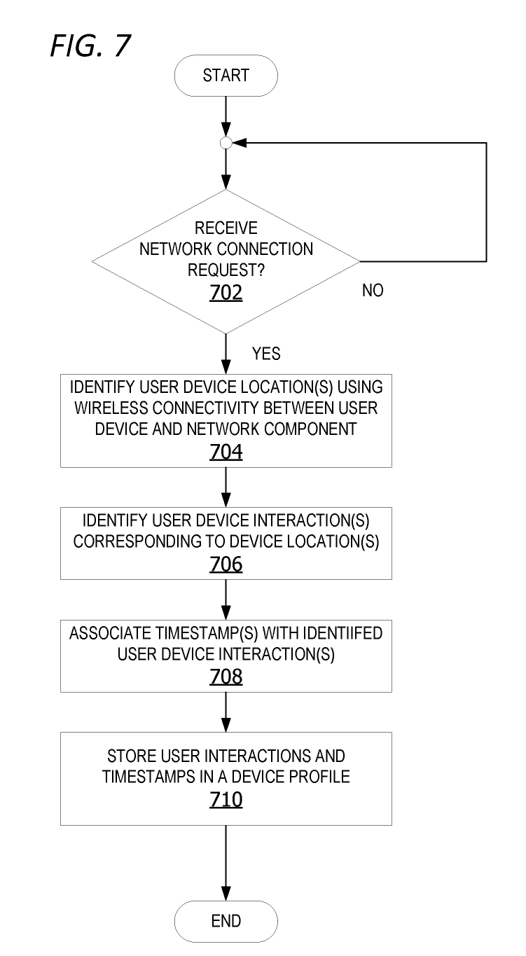

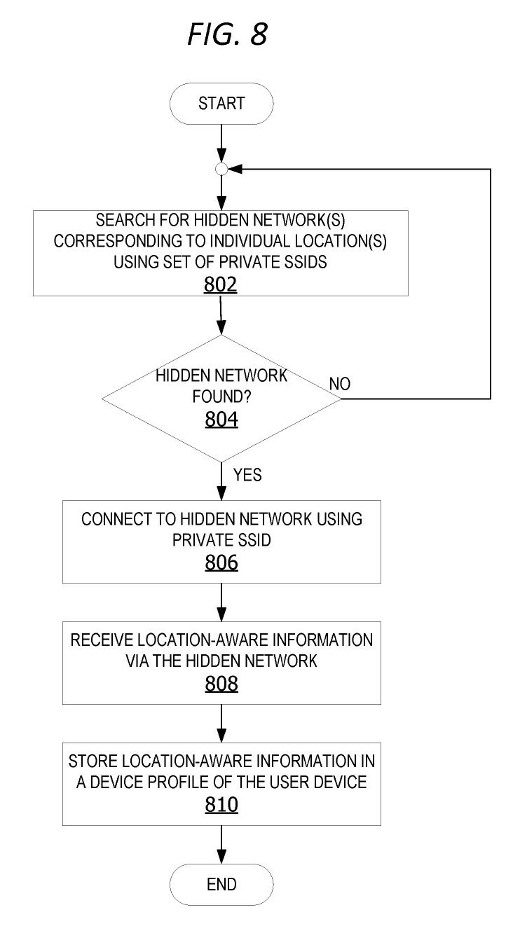

In some examples, the server 102 includes one or more processor(s) 108 and a memory 110. The processor(s) 108 include any quantity of processing units programmed to execute computer-executable instructions 112. The instructions may be performed by the processor(s) 108 or by multiple processors within the server(s) 102, or performed by a processor external to the server 102. In some examples, the one or more processor(s) 108 are programmed to execute instructions such as those illustrated in the figures (e.g., FIG. 6, FIG. 7, and FIG. 8).

In some examples, the processor represents an implementation of analog techniques to perform the operations described herein. For example, the operations may be performed by an analog computing device and/or a digital computing device.

The computing device further has one or more computer readable media such as the memory 110. The memory 110 includes any quantity of media associated with or accessible by the server 102. The memory 110 may be internal to the server 102 (as shown in FIG. 1), external to the server (not shown), or both (not shown). In some examples, the memory 110 includes read-only memory and/or memory wired into an analog computing device.

The memory 110 further stores a location-aware analysis engine 114. In this example, the location-aware analysis engine 114 sends a request for transaction data to one or more remote computing devices, such as computing device 106. The computing device 106 in this example is a computing device associated with a store or other retail location associated with a unique, private SSID. The SSID is a network name or network identifier.

When a user associated with the user device interacts with one or more items within the specific location, transaction data is generated by the computing device 106. A user interaction with an item may include purchasing the item, returning the item, scanning an item for a price check, downloading a coupon for the item, or any other interaction associated with the item. The location-aware analysis engine 114 receives the transaction data from the computing device 106 in real-time via a network 116, in this example.

The network 116 is implemented by one or more physical network components, such as, but without limitation, routers, switches, network interface cards (NICs), and other network devices. The network 116 may be any type of network for enabling communications, such as, but not limited to, a local area network (LAN), a wide area network (WAN), a wireless (Wi-Fi) network, or any other type of network. In this example, the network 116 is a Wide Area Network (WAN) accessible to the public, such as the Internet.

In other examples, the location-aware analysis engine 114 receives a request from a user device 104 associated with a user 130. The request in this example is a request for a portion of the transaction data that corresponds to a specified time and/or location. The requested portion of the transaction data is information associated with one or more transactions corresponding to the specified location and/or a specified time range. The requested portion of the transaction data may be identified by location-aware analysis engine 114 using transaction data received from one or more remote computing devices, such as computing device 106, and correlated with user device 104 based on the location and/or time.

The location aware analysis engine 114 analyzes transaction data received from one or more remote computing devices, such as computing device 106, to identify the portion of the transaction data corresponding to the requested time and/or location. The identified information responsive to the request is output to the user device 104 that made the request. The location-aware analysis engine 114 associates the identified information with a unique identifier for the requesting user device 104. The server 102 stores the associated information with the unique identifier in a device profile associated with the user device 104.

One or more device profiles corresponding to one or more user devices may be stored in a database 118 or other data storage on the server 102. In other examples, the device profile(s) 120 are stored on a remote data storage device or on a cloud located externally to the server 102. A remote data storage device may be accessed via the network 116.

In some examples, the server 102 optionally includes a communications interface component 122. The communications interface component includes a network interface card (NIC) and/or computer-executable instructions (e.g., a driver) for operating the NIC. Communication between the server 102, computing device 106, user device 104, as well as any other devices may occur using any protocol or mechanism over any wired or wireless connection. In some examples, the communications interface is operable with short range communication technologies such as by using near-field communication (NFC) tags.

In still other examples, the user device 104 includes a location-aware application 124. The location-aware application 124 sends the request for a portion of the transaction data corresponding to a specified time and/or specified location to the server 102. When the location-aware application 124 receives the identified information from the server 102 responsive to the request, the location-aware application 124 stores the identified transaction information in a device profile 126 stored on a data storage of the device or on a remote data storage associated with the user device 104. In some example, the device profile 126 is stored externally to the user device 104 on a cloud storage or other storage accessible via the network 116.

In some examples, the location-aware application 124 is a downloadable application. The location-aware application 124 may be implemented as a mobile application which is downloaded from the server 102 onto the user device 104 by a user 130. In other examples, following download of the application 124, the user 130 sets up preferences and favorite items using the application 124.

In yet other examples, the computing device 106 includes a device tracking engine 128. The device tracking engine 128 generates and/or stores the transaction data associated with a specific location corresponding to computing device 106 and outputs the transaction data for that specific location to the server 102 in response to a request from the server. In other examples, the device tracking engine 128 automatically sends the transaction data to the server 102 at regular intervals or at the occurrence of an event. The event may include generating transaction data, storing transaction data, an occurrence of a time interval, or any other example.

In some examples, the user device 104 constantly scans a store or other location for one or more private SSIDs. When the user device 104 enters the premises of the store or comes within range of the hidden network associated with the store, the server 102 sends notifications and/or other content regarding one or more items of interest or potential interest to the user device. The server 102 tracks sales history of items associated with transactions for the user device.

The server 102 sends content to the user device based on the transaction history and item interactions associated with the user device. Item interactions may include user interactions with items in a store or location. The server analyzers transaction history and item interactions to improve the content of item alerts, notifications, and other information delivered to the user device.

In other examples, the server 102 collects various data relating to the user device location and item interaction at various times. The server 202 analyzes this transaction data using a predictive engine and machine learning to algorithmically compile a profile of the user device. The user device is used to provide real-time, targeted content to the user device that may be specific to a location associated with the current location of the user device, for example.

The server 102 and the computing device 106 in this example are implemented as separate devices located remotely from each other. However, in other examples, the server 102 and computing device 106 may be implemented within a single device at a same location. In other words, the server may include the location-aware analysis engine as well as the device tracking engine on the same computing device within a given location.

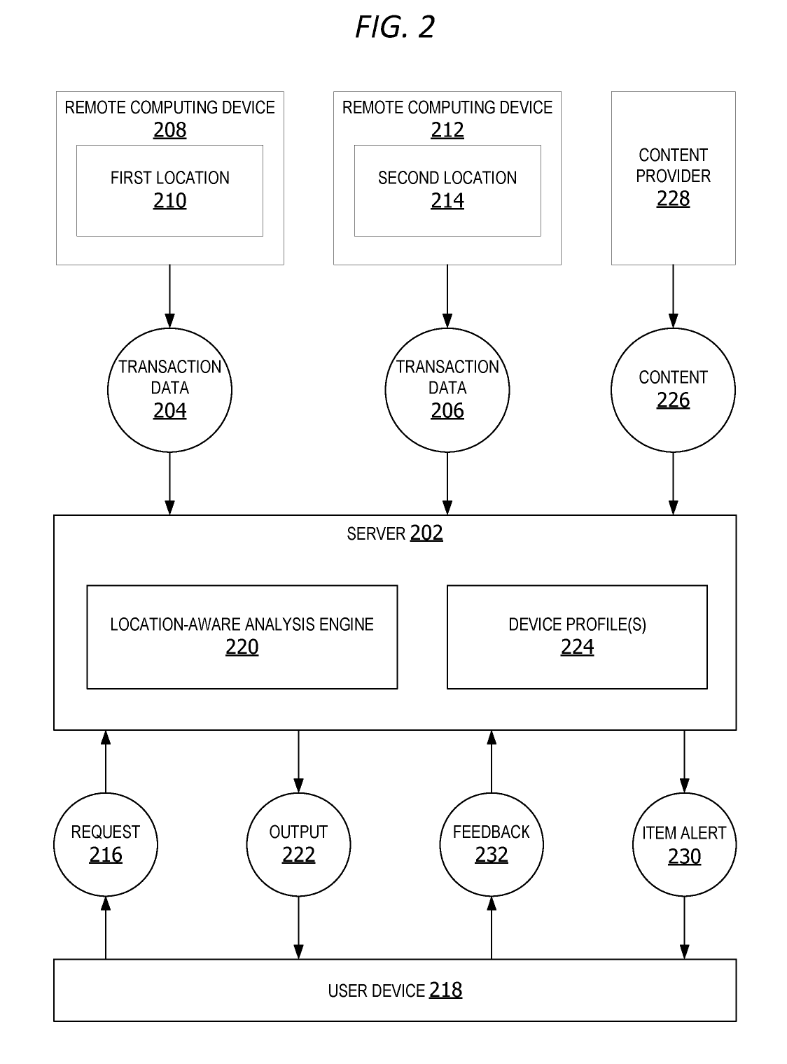

FIG. 2 is an exemplary block diagram illustrating location-aware device tracking by a server. In this example, the server 202 receives transaction data, such as transaction data 204 and transaction data 206, from one or more remote computing devices at one or more locations, such as remote computing device 208 at a first location 210 and remote computing device 212 at a second location 214. In this example, the server 202 receives transaction data from two remote computing devices associated with two different location. In other examples, the server 202 receives transaction data from three or more different locations.

In some examples, a remote computing device at a given location is a computing device associated with a store or other retail location. However, in other examples, the remote computing device 208 may be associated with an amusement park, fitness center, restaurant, or any other type of location.

In this example, when the server 202 receives a request 216 from a user device 218 for a portion of transaction data corresponding to a requested time span and a specific location. The location-aware analysis engine 220 analyzes the transaction data 204 and 206 to identify information responsive to the user device request 216. The identified information is output 222 to the user device. The location-aware analysis engine 220 stores the identified information in one or more device profile(s) 224 for the user device 218.

In other examples, the location-aware analysis engine 220 obtains content 226 from a content provider 228. The content 226 includes any type of information. The content 226 may include, for example but without limitation, information associated with a sale, item pricing, descriptions of goods, descriptions of services, new products, or other information associated with a given location at which the user device is currently located. The location-aware analysis engine 220 filters the content 226 against information in a device profile for the user device 218 to identify at least one item alert 230. An item alert 230 may include content associated with at least one item, for example. The item alert 230 in some non-limiting examples is an item price, item location within a store, item description, a sale price or other special associated with one or more items, or other information associated with an item. An item information may include a location of an item on a shelf, aisle, end-cap, or other location information.

In some examples, the device profile includes an identification of one or more items purchased or used by a user associated with the user device. The one or more items are identified by the location-aware analysis engine 220 performing an analysis of obtained transaction data. In these examples, the location-aware analysis engine 220 optionally filters the content 226 based on the one or more items associated with the specific location and the device profile for the user device 218. The location-aware analysis engine 220 outputs one or more item alerts 230 to the user device based on the history of items identified in a device profile for the user device 218.

In still other examples, the location-aware analysis engine 220 analyzes transaction data received from remote computing devices against user device location data obtained from the user device 218 to identify any transactions associated with the user device associated with the item alert 230.

The user device 218 may optionally provide user feedback 232 to the location-aware analysis engine 220. The feedback in some examples is provided in response to the user device 218 receiving the item alert 230. The feedback 232 may indicate the user's interest in the item associated with the alert 230 or the user's lack of interest in the item associated with the item alert 230. For example, the feedback 232 may indicate alert items that were purchased or not purchased after the alert was received.

In some examples, the device profile for the user device 218 is updated based on feedback 232 received from user device(s). The device profiles in some examples are updated dynamically, in real-time. In other examples, the updates occur periodically at a predetermined time interval.

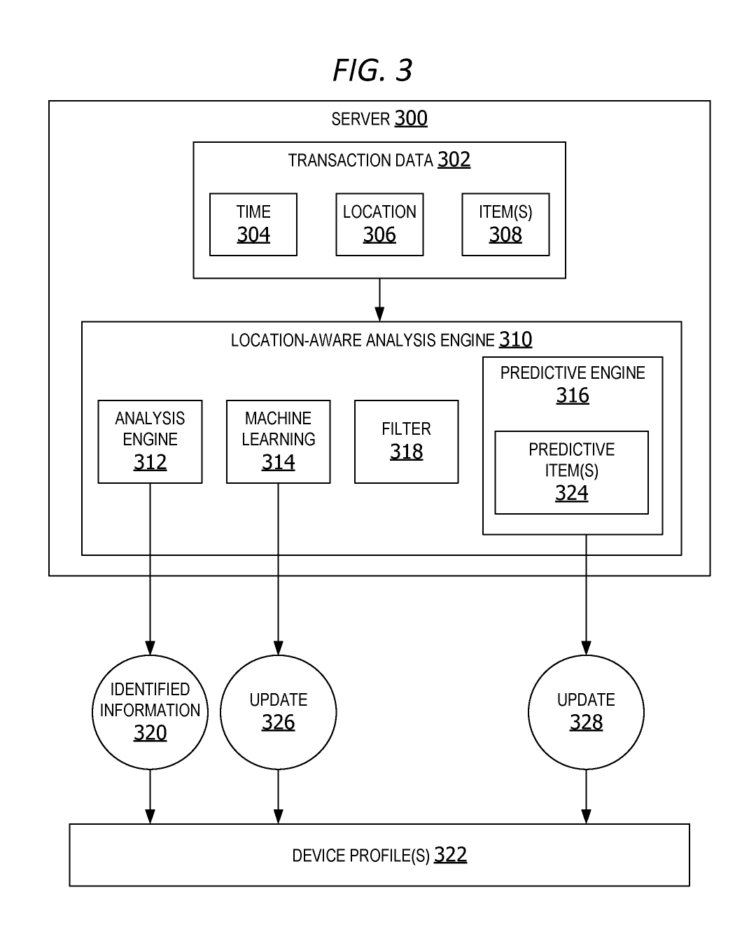

FIG. 3 is an exemplary block diagram illustrating a location-aware analysis engine. In this example, the server 300 receives or obtains transaction data 302. The transaction data 302 may include a time 304 at which a transaction took place, a location 306 at which the transaction took place, and an identification of one or more item(s) 308 purchased or otherwise associated with the transaction.

In some examples, the location 306 is a location of a store or other structure, such as a street address. For example, the location 306 may indicate that a user device is within a store located at 123 Main Street of a city. The location 306 may be associated with a unique SSID corresponding to the local network of the location, for example.

In still other examples, the location 306 includes a location within a store or other structure. For example, the location 306 may indicate the user device is within a produce section of the store located at 123 Main Street. In still other example, the location 306 indicates the user device is currently located within a portion of a specific aisle. In still other examples, the location 306 may include a location in latitude and longitude, a street address, an area, an aisle, or other location information.

The location-aware analysis engine 310 in this example includes an analysis engine 312, a machine learning 314 component, a predictive engine 316 and/or a filter 318. In some examples, the analysis engine 312 analyzes the transaction data 302 to obtain the identified information 320, which is stored in one or more device profile(s) 322 associated with one or more user devices.

In some examples, a predictive engine 316 analyzes the one or more device profile(s) 322, including the associated information identified from the transaction data 302 to identify one or more predictive item(s) 324 which may be of interest to one or more user(s) associated with a given user device. In other examples the predictive engine 316 performs an update 326 of the device profile(s) based on the predicted item(s) 324.

In some examples, the machine learning component 314 analyzes transaction history data to identify types of items, categories, genres, or classes of items of interest to one or more user(s) associated with a given user device. The machine learning component 314 may include pattern recognition, modeling, or other machine learning algorithms to analyze transaction data and identify item(s) of interest, transaction trends, and/or other patterns in transactions associated with a particular user device. The predictive engine 316 uses these identified items, trends, and/or transaction patterns to predict future transactions and identify new items of potential interest to the one or more user(s).

The predicted items of interest and/or potential future transactions are generated in some examples, when new transaction data is received. Theses predicted items of interest and/or potential future transactions may be used in some examples to generate an update 328 by the predictive engine 316. The update 328 is transmitted to the device profiles 322 in some examples.

In still other examples, when the server 300 receives or obtains new transaction data, the analysis engine 312 processes the transaction data to generate analyzed transaction data. The machine learning 314 component processes the device profile(s) 322 using the analyzed transaction data to update 326 the device profile(s) with transaction information associated with one or more items involved in a transaction, a location of a transaction, and/or a time a transaction associated with a given user device occurred.

A filter 318 optionally filters content received from a content provider against item(s) identified in one or more device profile(s) 322 to identify an alert item based on the user device transaction history, current user device location, current time, previous items purchased, and/or other data in the device profile.

An alert item is a notification of an item of potential interest to a user associated with the user device. In some examples, when the location-aware application in a user device detects a network SSID in range, it downloads any sales or deals for that location. If the deals or sale match customer preferences/previous purchase history, the user device may present an item alert regarding the deal/sale to the user via the user device.

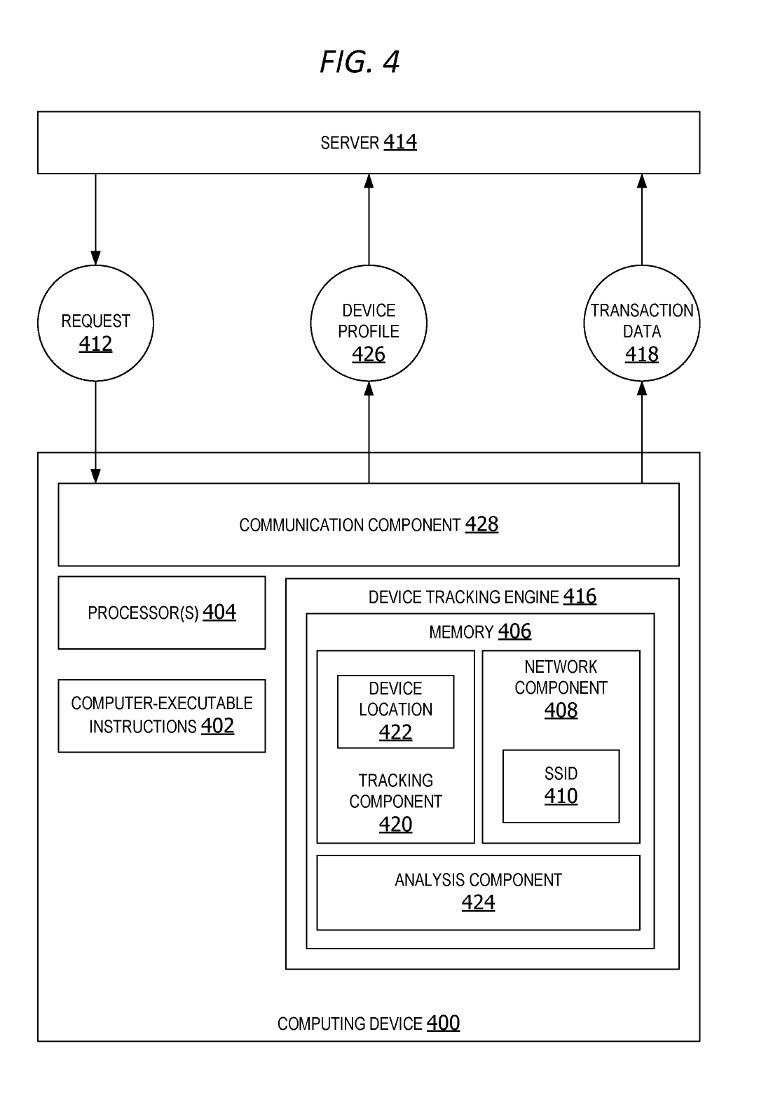

FIG. 4 is an exemplary block diagram illustrating a computing device for location-aware device tracking. The computing device 400 represents any device executing computer-executable instructions 402 (e.g., as application programs, operating system functionality, or both) to implement the operations and functionality associated with the computing device 400. The computing device 400 may include a mobile computing device or any other portable device. The computing device may also include less portable devices such as desktop personal computers, kiosks, tabletop devices, industrial control devices, wireless charging stations, and electric automobile charging stations. Additionally, the computing device may represent a group of one or more processing units or other computing devices.

In some examples, the computing device 400 includes one or more processor(s) 404 and a memory 406. The processor(s) 404 include any quantity of processing units programmed to execute the computer-executable instructions 402. The instructions may be performed by the processor or by multiple processors within the computing device 400, or performed by a processor external to the computing device 400. In some examples, the processor is programmed to execute instructions such as those illustrated in the figures (e.g., FIG. 6, FIG. 7 and FIG. 8).

In this example, a network component 408 includes a private SSID 410. The network component 408 may be associated with one or more network devices, such as, but not limited to, a wireless router or network adapter.

When the network component 408 receives a request for a network connection from a user device, the network component 408 determines if the request includes the private SSID 410. If the request includes the private SSID 410, the network component 408 establishes a connection and provides wireless connectivity to the user device. If the request does not include the private SSID 410, no network connection is established between the user device and the network component 408.

A tracking component 420 tracks the user device within a given monitored area associated with the location of the network component. The given monitored area is an area within a range of the wireless network provided by the network component 408. The tracking component 420 optionally identifies one or more device location(s) 422 of the user device within the monitored area or range of the wireless network using the wireless connectivity between the user device and the network component 408.

In some examples, the tracking component 420 tracks the user device as it is moved by a user throughout a store or other location. The tracking component 420 may determine a location of the user device, identify products located within a given range of the user device, determine a time or time span during which the user device is at a point of sale (POS) device, identify transactions occurring at the same time or relative to the time span in which the user device was at the POS device, determines a time when the user device left a range of the location's network, and other transaction-related data. The time when the user device left a range of the location's network is a time at which the user device disengaged or logged out of the store or location network (dropped connection).

When the user device leaves the range of the location's network, in some examples, the user device queries the central server for purchases/transactions made within the time span during which the user device was within the range of the location network. The user device uses the transaction data received from the server to identify products and/or purchases that correlate with the user device, and may store such identified information in a device profile for the user device.

In other examples, an analysis component 424 identifies one or more items corresponding to the one or more device location(s) 422. In one non-limiting example, if a user device location is at a POS device, the analysis component 424 identifies one or more items purchased during a transaction occurring at the POS device corresponding to the user device. The analysis engine may obtain the data associated with the transaction from the POS device or from a data storage associated with the POS device, for example.

In another example, if a user device location is near an end-cap display, the analysis component 424 analyzes transaction data, location data identifying items on the end-cap display, and/or the device location to identify one or more items in a proximity to the user device which may be of interest to the user.

The analysis component 424 in other examples determines a time span associated with the wireless connectivity between the user device and the network component 408. The time span is a length of time the user device is connected to the wireless network generated or provided by the network component 408.

In still other examples, the analysis component 424 obtains transaction data corresponding to the time span during which the user device is connected to the wireless network. The transaction data, the given time span, and the one or more identified items are optionally stored in a device profile 426.

The device profile 426 is optionally sent to the server 414. In other examples, the device profile 426 for a given user device is sent to the given user device. In still other examples, the device profile 426 is stored in a data storage associated with the computing device 400. In yet another example, the device profile 426 may be stored on a cloud storage.

A communication component 428 receives a request 412 from another computing device at another network, such as server 414. The request may include a request for transaction data 418. The request in some examples include a time span and/or location data. The device tracking engine 416 sends the requested transaction data 418 to the server 414.

The server 414 may send requests to multiple different remote computing systems at one or more different locations. Likewise, the server 414 may receive transaction data from multiple different device tracking engines associated with computing devices at one or more different locations.

In some examples, when a user device enters or approaches, or otherwise comes into proximity with, a given location, the user device may attempt to connect with the given location's network using the private SSID for that particular location. In some examples, the user device location-aware application stores a set of unique private SSIDs associated with individual locations and uses the stored set to prompt or otherwise direct the user device to log into the location's network when a particular SSID is detected in range of the user device.

The device tracking engine 416 in some examples collects data relating to the user device location and item interaction. The server 414 utilizes a predictive engine and machine learning to algorithmically compile a profile of the user device. The user device profile is used by the server 414 to provide real-time content to the user device. The server 414 tracks sales history associated with the user device and adds most-purchased items to a list of favorites. The server 414 sends notifications of sales on most-purchased items, previously purchased items, and/or predicted potential items to be purchased in the future to the user device. In these examples, the data associated with the user device, including sales history and transaction history, is stored as a device profile in a customer-agnostic manner such that consumer privacy is maintained and the customer associated with the user device remains anonymous to the system described herein.

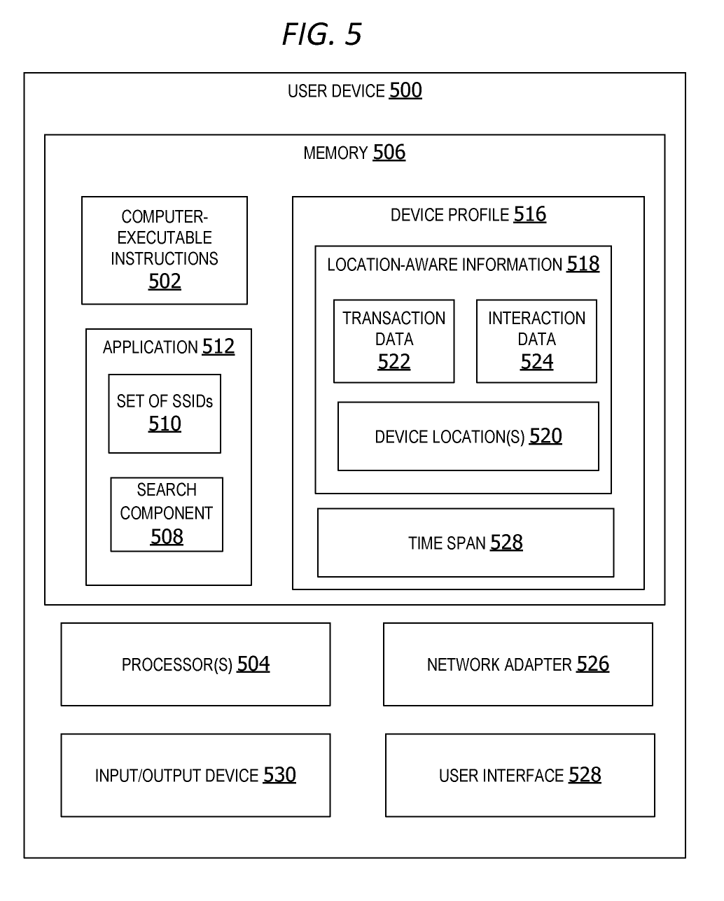

FIG. 5 is an exemplary block diagram illustrating a user device. The user device 500 represents any device executing computer-executable instructions 502 (e.g., as application programs, operating system functionality, or both) to implement the operations and functionality associated with the user device 500.

The user device 500 may include a mobile computing device or any other portable device. In some examples, the mobile computing device includes a mobile telephone, laptop, tablet, computing pad, netbook, gaming device, and/or portable media player. Additionally, the computing device may represent a group of processing units or other computing devices.

In some examples, the user device 500 includes one or more processor(s) 504 and a memory 506. The processor(s) 504 includes any quantity of processing units, and is programmed to execute computer-executable instructions 502. The instructions may be performed by the one or more processor(s) 504 internal to the user device 500, or performed by one or more processor(s) external to the user device 500. In some examples, the processor is programmed to execute instructions such as those illustrated in the figures (e.g., FIG. 6, FIG. 7, and FIG. 8).

A search component 508 of a location-aware application 512 constantly searches for one or more hidden networks associated with individual locations using a set of private SSIDs. In some examples, a hidden network is a wireless network, such as, but not limited to, network 116 in FIG. 1.

In still other examples, the search component 508 is located separately from the location-aware application 512. In these examples, the search component 508 is native to the user device 500. The search component optionally sends instructions to the location-aware application 512. The search component in these examples may communicate with the location-aware application 512 via an application programming interface (API).

In some examples, a location-aware application 512 instructs the search component 508 to search for the hidden networks using a set of one or more private SSIDs 510 at application startup. In other words, the application 512 instructs the user device to search for the known network names provided by the set of SSIDs in the application 512 without revealing the network name(s) to a user associated with the user device.

In other examples, the location-aware application 512 provides the set of private SSIDs to the search component 508. The search component 508 utilizes the set of SSIDs 510 to search for the hidden networks. If an individual SSID in the set of SSIDs corresponds to the private SSID for a wireless network device in the current location of the user device, the user device connects to the hidden network using the private SSID. The network connection may be established in some examples via a network adapter 526.

When the application 512 detects the private SSID for a store or other location, the application logs into the store's tracking system. When the user device is connected to the hidden network, the user device requests location-aware information 518 from the local tracking component of the computing device associated with the current location of the user device, such as tracking component 420 in FIG. 4. The location-aware information 518 in some examples includes user device location(s) 520 data, interaction data 524 associated with the specific location of the user device 500, and/or transaction data 522 associated with the user device 500.

In some examples, the location-aware application 512 requests transaction data 522 for a specified time span 528 from a central network server, such as server 102 in FIG. 1. The time span 528 in this example, is a time span during which the user device is connected to the hidden network of a particular location. The time span begins when the network connection is established and ends when the network connection is terminated.

The user device receives the location-aware information 518 from the local tracking component via the hidden network. In some examples, the location-aware information 518 is stored in a device profile 516 associated with the user device 500. The device profile 516 is user device specific and user anonymous. In other words, the device profile does not include user identifying information. This maintains the privacy of the one or more users associated with the user device 500.

In other examples, the user device 500 receives content associated with the specified location of the user device 500. In some examples, the content is targeted content associated with one or more items sold or otherwise available in the specified location. In still other examples, the content is content associated with one or more items present within a proximity of the user device.

In other examples, the user device 500 receives targeted content corresponding to a specific location and/or one or more items within the specific location when the user device connects to the hidden network. In these examples, the content is delivered as a user associated with the user device arrives at a store associated with the specific location. The content may be generated based on a history of prior transactions associated with the user device and/or predictions regarding potential future transactions.

The user device 500 in some examples includes a user interface 528 component. The user interface 528 may include a graphical user interface (GUI), command line interface, menu-driven interface, or any other type of interface. The received targeted content may be displayed to one or more users via the user interface or otherwise output to the user interface 528 of the user device 500.

In still other examples, the user device 500 optionally includes an input/output device 530. The input/output device 530 includes any device for outputting data to the user or receiving input from the user. The input/output device 530 may include a display screen, a projector, a speaker, microphone, or any other type of input and/or output device. Displaying the targeted content to the one or more users via the input/output device may include presenting visual output and/or audio output.

In some examples, the location-aware application 512 is a mobile application. A user downloads the location-aware application 512. The user optionally sets up product preferences and favorites on the application 512. When the user enters a retail store, the presence of the user's mobile device is detected. The location of the user device is determined.

FIG. 6 is an exemplary flowchart illustrating operation of a computing device for generating identified information for location-aware device tracking. The process shown in FIG. 6 may be performed by an analysis engine executing on a computing device, such as, but not limited to, the location-aware analysis engine 114 in FIG. 1, the location-aware analysis engine 220 in FIG. 2, or the analysis engine 312 in FIG. 3. The computing device may be implemented as a computing device such as, but not limited to, server 102 in FIG. 1, the server 202 in FIG. 2, the server 300 in FIG. 3, or the server 414 in FIG. 4. Further, execution of the operations illustrated in FIG. 6 is not limited to an analysis engine. One or more computer-readable storage media storing computer-readable instructions may execute to cause at least one processor to implement the operations illustrated in FIG. 6.

The process begins by determining whether a request for transaction data is received at operation 602. If yes, transaction data is obtained from one or more specific locations at operation 604. The transaction data is analyzed to identify the requested data at operation 606. The requested transaction data is output to the requesting user device at operation 608. The obtained transaction data is stored in a device profile for the requesting user device at 610.

A determination is made as to whether to continue at operation 612. If no, the process terminates thereafter. If a determination is made to continue at operation 612, the process returns to operation 602 to wait for a user device request. In some examples, a determination is made to continue if transaction data is received from a given location and/or if a request for transaction data is received from one or more user devices. In this manner, the process iteratively checks for transaction data requests and/or obtained data, stores the transaction data when obtained, and waits for a next request for transaction data from one or more user devices.

While the operations illustrated in FIG. 6 are performed by a computing device or server, aspects of the disclosure contemplate performance of the operations by other entities. For example, a cloud service may perform one or more of the operations.

FIG. 7 is an exemplary flowchart illustrating operation of a computing device for generating a device profile. The process shown in FIG. 7 may be performed by a device tracking engine executing on a computing device, such as, but not limited to, the device tracking engine 128 in FIG. 1 and device tracking engine 416 in FIG. 4. The computing device may be implemented as a computing device such as, but not limited to, the computing device 106 in FIG. 1, remote computing device 208 or 212 in FIG. 2, or computing device 400 in FIG. 4. Further, execution of the operations illustrated in FIG. 7 is not limited to a device tracking engine. One or more computer-readable storage media storing computer-readable instructions may execute to cause at least one processor to implement the operations illustrated in FIG. 7.

The process begins by determining whether a request for a network connection is received from a user device at operation 702. User device location(s) are identified using wireless connectivity between user device and network component at operation 704. One or more user device interaction(s) corresponding to the device location(s) are identified at operation 706. The user device interaction(s) may be, for example, interactions with one or more items, interactions with one or more areas of a location, interactions with one or more entities, and/or any other suitable interaction identified based on user device location. Individual timestamps are associated with the one or more identified user device interactions at operation 708. The identified one or more user device interaction(s) and associated individual timestamps are stored in a device profile for the user device at operation 710, with the process terminating thereafter.

While the operations illustrated in FIG. 7 are performed by a computing device or server, aspects of the disclosure contemplate performance of the operations by other entities. For example, a cloud service may perform one or more of the operations.

FIG. 8 is an exemplary flowchart illustrating operation of a user device for obtaining location-aware information. The process shown in FIG. 8 may be performed by a location-aware application executing on a computing device, such as, but not limited to, the location-aware application 124 in FIG. 1, or application 512 in FIG. 5. The computing device may be implemented as a computing device such as, but not limited to, user device 104 in FIG. 1, user device 218 in FIG. 2, or user device 500 in FIG. 5. Further, execution of the operations illustrated in FIG. 8 is not limited to a location-aware application. One or more computer-readable storage media storing computer-readable instructions may execute to cause at least one processor to implement the operations illustrated in FIG. 8.

The process begins by searching for one or more hidden networks corresponding to individual locations using a stored set of private SSIDs at operation 802. The set of private SSIDs correspond to one or more SSIDs for individual locations. The user device searches for a hidden network having a private SSID corresponding to at least one private SSID in the set of private SSIDs.

The process determines whether a hidden network is found at operation 804. If a hidden network is found, a connection to the hidden network is established using the private SSID at operation 806. If a hidden network is not found, the process iteratively searches for one or more hidden networks. Location-aware information is received via the connected hidden network at operation 808. The location-aware information is stored in a device profile of the user device at operation 810. The process terminates thereafter.

While the operations illustrated in FIG. 8 are performed by a computing device or server, aspects of the disclosure contemplate performance of the operations by other entities. For example, a cloud service may perform one or more of the operations.

### ADDITIONAL EXAMPLES

At least a portion of the functionality of the various elements in FIG. 1, FIG. 2, FIG. 3, FIG. 4, and FIG. 5 may be performed by other elements in FIG. 1, FIG. 2, FIG. 3, FIG. 4, and FIG. 5, or an entity (e.g., processor, web service, server, application program, computing device, etc.) not shown in FIG. 1, FIG. 2, FIG. 3, FIG. 4, and FIG. 5.

In some examples, the operations illustrated in FIG. 6, FIG. 7, and FIG. 8 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

Alternatively, or in addition to the other examples described herein, examples include any combination of the following:
analyzes the one or more device profiles, including the associated information identified from the obtained transaction data, to identify one or more items associated with individual devices uniquely identified in the one or more device profiles;
generates a prediction of at least one other item to associate with at least one other individual device;
receives another request from the user device for another portion of the transaction data corresponding to another time span and another specific location;
analyzes the obtained transaction data to identify other information associated with the other portion of the transaction data;
outputs the other identified information to the user device;
updates the device profile for the user device with the other identified information;
a machine learning component that processes and updates the one or more device profiles using the analyzed transaction data from the analysis engine in response to received requests;
a predictive engine that associates one or more predicted items with the device profile based on an identification of one or more transaction items associated with the device profile;
receives, from the user device, location identifier data associated with the specific location of the one or more locations;
determines one or more items associated with both the specific location and the device profile using the location identifier data;
obtains content from a content provider associated with the specific location;
filters the obtained content against the determined one or more items to identify at least one item alert;
outputs the at least one item alert to the user device;
determines one or more predicted items based on the device profile;
filters the obtained content against the determined one or more predicted items to identify at least one other item alert;
outputs the at least one other item alert to the user device;
obtains additional transaction data associated with the location identifier data;
analyzes the additional transaction data against device location data obtained for the user device to identify whether any transactions are associated with the output at least one item alert;
updates the device profile based on the analysis of the additional transaction data;
receives user feedback in response to the output at least one item alert;
updates the device profile based on the received user feedback;
a communication component that receives a request from a system at another network for the device profile associated with the user device and provides the device profile to the system at the other network;
wherein the communication component receives another request from the system at the other network for another device profile associated with another user device;
wherein the location-aware information includes at least one of device location data associated with the specific location, interaction data associated with the specific location and the user device, or transaction data associated with the user device;
wherein an application executing on the user device provides the private SSID to the user device for the searching step
wherein the application instructs the user device to search for the private SSID upon application startup
communicating with a central network to request transaction data corresponding to a time span;
receiving the requested transaction data from the central network
storing the received transaction data in the device profile;
wherein the time span corresponds to a connection time between the user device and the hidden network;
wherein the private SSID provides a unique location identifier to the user device;
receiving targeted content associated with the specific location upon connecting to the hidden network.

The term “roaming” as used herein refers, in some examples, to connectivity provided outside a subscriber's home zone that may be subject to additional tariffs, fees, or constraints. Roaming service may or may not be provided by the same mobile operator. The term “tethered” as used herein refers, in some examples, to situations where one device acts as an access point for another device for network access. A tethered connection may occur over a wired connection or a wireless connection. The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for a location-aware device tracking system. For example, the elements illustrated in FIG. 1, FIG. 2, FIG. 3, FIG. 4, and FIG. 5, such as when encoded to perform the operations illustrated in FIG. 6, FIG. 7, and FIG. 8, constitute exemplary means for obtaining transaction data in real-time from one or more remote systems, the transaction data associated with one or more locations; exemplary means for receiving a request from a user device for a portion of the transaction data corresponding to a time span and a specific location from the one or more locations, the user device having a unique identifier; exemplary means for analyzing the obtained transaction data to identify information associated with the portion of the transaction data corresponding to the requested time span and the specific location; exemplary means for outputting the identified information to the user device, associate the identified information with the unique identifier of the user device; and exemplary means for storing the associated information with the unique identifier in a device profile of the one or more device profiles.

In other examples, the elements illustrated in FIG. 1, FIG. 2, FIG. 3, FIG. 4, and FIG. 5, such as when encoded to perform the operations illustrated in FIG. 6, FIG. 7, and FIG. 8, constitute exemplary means for receiving a request from a user device for network connection using a private SSID and provides wireless connectivity to the user device for a specific location; exemplary means for identifying one or more device locations for the user device within the specific location using the wireless connectivity between the user device and the network component; and exemplary means for identifying one or more user device interactions that correspond to one or more locations, obtaining transaction data associated with a timestamp, and storing identified one or more user device interactions, the associated timestamps, and the obtained transaction data in a device profile associated with the user device.

In still other examples, For example, the elements illustrated in FIG. 1, FIG. 2, FIG. 3, FIG. 4, and FIG. 5, such as when encoded to perform the operations illustrated in FIG. 6, FIG. 7, and FIG. 8, constitute exemplary means for searching for a hidden network corresponding to individual location(s) using a set of private SSIDs; exemplary means for connecting to the hidden network using one or more private SSIDs; exemplary means for receiving location-aware information via the hidden network; and exemplary means for storing the location-aware information in a device profile for the user device. The user device profile is user-anonymous.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computing system for location-aware device tracking, the computing system comprising:
a memory device storing data associated with one or more device profiles and computer-executable instructions;
a processor communicatively coupled to the memory device; and
an analysis engine implemented on the processor that:
obtains transaction data in real-time from one or more remote systems, the transaction data associated with one or more locations;
receives a request from a user device for a portion of the transaction data corresponding to a time span and a specific location from the one or more locations, the user device having a unique identifier;
analyzes the obtained transaction data to identify information associated with the portion of the transaction data corresponding to the requested time span and the specific location;
outputs the identified information to the user device, associate the identified information with the unique identifier of the user device; and
store the associated information with the unique identifier in a device profile of the one or more device profiles.

2. The computing system of claim 1, wherein the analysis engine further:
analyzes the one or more device profiles, including the associated information identified from the obtained transaction data, to identify one or more items associated with individual devices uniquely identified in the one or more device profiles; and
generates a prediction of at least one other item to associate with at least one other individual device.

3. The computing system of claim 1, wherein the analysis engine further:
receives another request from the user device for another portion of the transaction data corresponding to another time span and another specific location;
analyzes the obtained transaction data to identify other information associated with the other portion of the transaction data;
outputs the other identified information to the user device; and
updates the device profile for the user device with the other identified information.

4. The computing system of claim 1, further comprising:
a machine learning component that processes and updates the one or more device profiles using the analyzed transaction data from the analysis engine in response to received requests.

5. The computing system of claim 1, further comprising:
a predictive engine that associates one or more predicted items with the device profile based on an identification of one or more transaction items associated with the device profile.

6. The computing system of claim 1, wherein the analysis engine further:
receives, from the user device, location identifier data associated with the specific location of the one or more locations;
determines one or more items associated with both the specific location and the device profile using the location identifier data;
obtains content from a content provider associated with the specific location;
filters the obtained content against the determined one or more items to identify at least one item alert; and
outputs the at least one item alert to the user device.

7. The computing system of claim 6, wherein the predictive engine further:
determines one or more predicted items based on the device profile;
filters the obtained content against the determined one or more predicted items to identify at least one other item alert; and
outputs the at least one other item alert to the user device.

8. The computing system of claim 6, wherein the analysis engine further:
obtains additional transaction data associated with the location identifier data;
analyzes the additional transaction data against device location data obtained for the user device to identify whether any transactions are associated with the output at least one item alert; and
updates the device profile based on the analysis of the additional transaction data.

9. The computing system of claim 6, wherein the analysis engine further:
receives user feedback in response to the output at least one item alert; and
updates the device profile based on the received user feedback.

10. One or more computer storage devices having computer-executable instructions stored thereon for location-aware device tracking, which, on execution by a computer, cause the computer to perform operations comprising:
a network component that, upon execution by the computer, receives a request from a user device for network connection using a private SSID and provides wireless connectivity to the user device for a specific location;
a tracking component that, upon execution by the computer, identifies one or more device locations for the user device within the specific location using the wireless connectivity between the user device and the network component; and
an analysis component that, upon execution by the computer, identifies one or more interactions that correspond to the one or more device locations for the user device within the specific location, associates individual timestamps with the one or more identified interactions, and stores the identified one or more interactions and the associated individual timestamps as transaction data in a device profile associated with the user device.

11. The one or more computer storage devices of claim 10, further comprising:
a communication component that receives a request from a system at another network for the device profile associated with the user device and provides the device profile to the system at the other network.

12. The one or more computer storage devices of claim 11, wherein the communication component receives another request from the system at the other network for another device profile associated with another user device.

13. A computer-implemented method for location-aware device tracking, the computer-implemented method comprising:
searching, by a user device, for one or more hidden networks corresponding to individual locations using a set of private SSIDs;
connecting to a hidden network using a private SSID from the set of private SSIDs;
receiving location-aware information via the connected hidden network from a local tracking component; and
storing the location-aware information in a device profile of the user device, wherein the device profile is user-anonymous.

14. The computer-implemented method of claim 13, wherein the location-aware information includes at least one of device location data associated with the specific location, interaction data associated with the specific location and the user device, or transaction data associated with the user device.

15. The computer-implemented method of claim 13, wherein an application executing on the user device provides the private SSID to the user device for the searching step.

16. The computer-implemented method of claim 15, wherein the application instructs the user device to search for the private SSID upon application startup.

17. The computer-implemented method of claim 13, further comprising:
communicating with a central network to request transaction data corresponding to a time span;
receiving the requested transaction data from the central network; and
storing the received transaction data in the device profile.

18. The computer-implemented method of claim 17, wherein the time span corresponds to a connection time between the user device and the hidden network.

19. The computer-implemented method of claim 13, wherein the private SSID provides a unique location identifier to the user device.

20. The computer-implemented method of claim 13, further comprising:
receiving targeted content associated with the specific location upon connecting to the hidden network.
